(19) United States
(12) Patent Application Publication
(10) Pub. No.: US 2014/0215908 A1
(43) Pub. Date: Aug. 7, 2014

(54) Tree Ring Assembly

(71) Applicant: Scott Ta, Wichita, KS (US)

(72) Inventor: Scott Ta, Wichita, KS (US)

(21) Appl. No.: 14/144,990

(22) Filed: Jan. 23, 2014

(51) Int. Cl. A01G 13/00

(52) U.S. Cl. CPC A01G 13/0237
USPC 47/32.4

(57) ABSTRACT

A tree ring including a tube having an upper end, a lower end, and an outer wall; a ground flange having an outer end, the ground flange being fixedly attached to and extending outwardly from the tube's outer wall, the ground flange further extending annularly about the tube; a plurality of seams, each seam among the plurality of seams segmenting the tube and the ground flange; pairs of flanges connected operatively at the seams, the flange pairs being adapted for interconnecting the tube's segments and the ground flange's segments; and a plurality of “T” sleeves, each sleeve among the plurality of “T” sleeves being fitted for receiving and securing together one of the flange pairs and for securing the segments in a tree ringing pattern.

### FIELD OF THE INVENTION

This invention relates to landscaping and “hardscaping”. More particularly, this invention relates to tree rings used in landscaping and “hardscaping”.

### BACKGROUND OF THE INVENTION

Tree rings are commonly utilized in the landscaping or “hardscaping” arts for defining a perimeter boundary about the bases of trees, shrubs, planting beds and the like, such rings commonly performing functions of holding and containing mulch, holding and containing moisture, and defining a peripheral edge surfaces for assisting in lawn and edging foliage and trimming. Such tree rings are commonly bulky and heavy, are difficult to ship and display on store shelves, they are not economically fabricated, they are often difficult to assemble and utilize, and they are often breakable, lacking durability.

The instant inventive tree ring assembly solves or ameliorates the problems, defects, and deficiencies noted above by providing a specially configured tree ring components which allow a small number of commonly configured plastic injection molded tree ring parts or segments to be shipped, offered and displayed for sale, and interconnected in various tree ringing configurations by the end user.

### BRIEF SUMMARY OF THE INVENTION

A first structural component of the instant inventive tree ring comprises a tube having an upper end, a lower end, and having inner and outer walls. In a preferred embodiment, the vertical height of the tube is approximately six inches, suitably ranging between 5″ and 7″. The horizontal diameter of the tube is preferably between three and four feet, and the wall thickness of the tube is between 3/16″ and 5/16″. In the preferred embodiment, the tube component is composed of durable injection molded plastic.

A further structural component of the instant inventive tree ring comprises a ground flange having a peripheral outer end, and having an inner end which is preferably fixedly attached to or formed wholly via an injection molding process with the tube's outer wall. Where the tube has a vertical height dimension of six inches, as is preferred, the ground flange component is preferably situated thereon at an elevation approximately two inches below the upper end of the tube. In a preferred embodiment, the ground flange cantilevers horizontally outward from the tube between four and six inches.

Further structural components of the instant inventive tree ring assembly comprise a plurality of seams which segment the tube and ground flange at preferably even intervals. Where the tube and ground flange components are substantially circular, the assembly's seam components preferably segment the tube and ground flange at 90° intervals. Suitably, the seam components may be provided and positioned for alternatively segmenting the tube and ground flange at 30°, 45°, or 60° intervals.

In the preferred 90° arc segments embodiment, the outer edge of the ground flange is octagonal with each 90° segment forming a complete centrally positioned octagon edge and forming a pair of octagon edge halves. Such segmented octagonal ground flange configuration assists the invention's end user in arranging the invention's segments in various desirable tree ring shapes.

Further structural components of the instant inventive tree ring assembly comprise fastening means which are connected operatively at the seams. In a preferred embodiment, the fastening means comprise pairs of abutting flanges which are securely held together in an end-to-end fashion with respect to each other via a provided plurality of “T” shaped fastening sleeves. Other commonly known fastening means such as snap lug and snap socket combination fasteners, snap channel and snap ridge combination fasteners, “L” hook and slot combination fasteners, pin and keyhole slot fasteners, slide ridge and slide channel combination fasteners, and pin and eye combination fasteners may be suitably substituted as means for interconnecting the assembly's segments. Such alternative fasteners are considered to fall within the scope of the invention.

In use of the instant inventive tree ring assembly, and assuming that an end user consumer wishes to purchase and install about a tree (or bushes, shrubbery, or other plantings, as the case may be) a circular tree ring, a manufacturer of the instant inventive assembly may fabricate and supply at sales outlets multiplicities of substantially identical 90° tube and flange segments, each such segment including end fastening features as described above. Such manufacturer may additionally manufacture and correspondingly supply multiplicities of fitted “T” sleeves which nestingly receive and secure the flanged ends of the tube and ground flange segments. Thereafter, such end user may simply purchase four renditions of such 90° tube and ground flange segment and may purchase four “T” sleeves. Thereafter, the end user may, in a simple, convenient, and economic fashion, interconnect the four 90° segments at their flanged ends to form a ring, the ring segments being held together by four “T” sleeves.

Such circular tree ring may be assembled and installed about the base of the tree, and in such usage, the lower end of the tube (i.e., the portion extending downwardly from the ground flange) may effectively peripherally line the tree's planting pit wall at and about the pit's upper opening, such peripheral lining advantageously holding the segments of the ring together and serving as a moisture retaining barrier. Also in such usage, the upper end of the tube (i.e., the portion of the tube which extends upwardly from the ground flange) advantageously serves as a mulch retaining wall. Also in such usage, the ground flange advantageously serves as an insertion stop which holds the upper and lower extensions of the tube at their desired below ground and above ground position, and the ground flange serves as a convenient edging border which assists in grass trimming.

Accordingly, objects of the instant invention include the provision of a tree ring assembly which incorporates structures as described above, and which arranges those structures in manners described above, for achievement of the objects, benefits, and advantages described above.

Other and further objects, benefits, and advantages of the present invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive tree ring.

FIG. 2 is a perspective view of one of the “T” sleeve components.

FIG. 3 is a magnified view of a portion of the structure of FIG. 2, as indicated in FIG. 2.

FIG. 4 redepicts the structure of FIG. 3, the view showing the “T” sleeve removed.

FIG. 5 presents an alternative oblongated version of the inventive tree ring assembly.

### DETAILED DESCRIPTION OF PREFERRED EMBODIMENTS

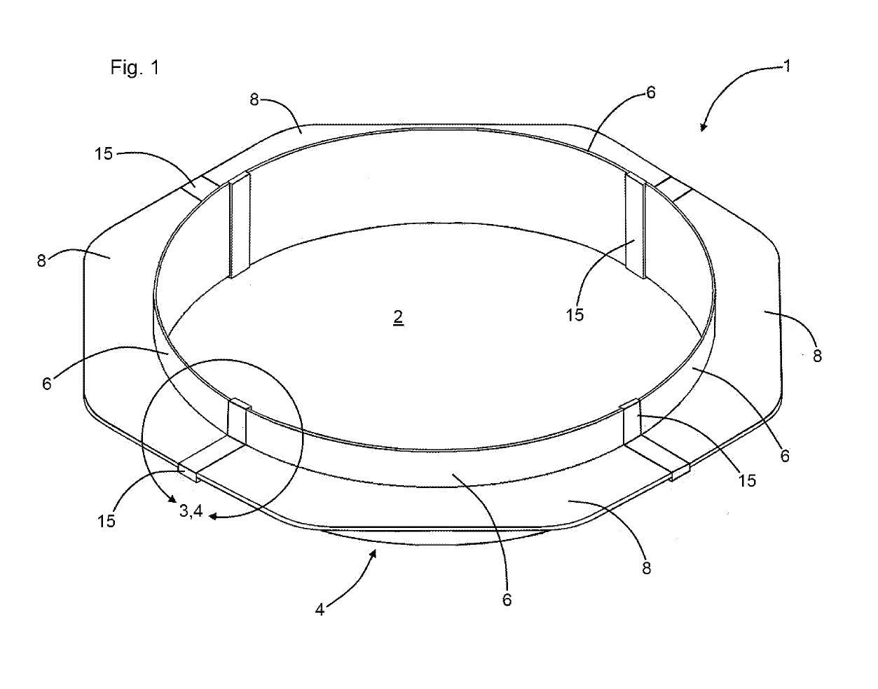

Referring now to the drawings and in particular to Drawing FIG. 1, a preferred embodiment of the instant inventive tree ring assembly is referred to generally by Reference Arrow 1. A primary structural component of the assembly 1 may comprise a quadruple of 90° arc tube/ground flange segments which are referred to generally by Reference Arrow 4. Each of such segments 4 may comprise an upwardly and downwardly extending tube segment 6 which in combination with other substantially identical segments may define an interior tree, bush, or shrubbery planting space 2. Annularly or circumferentially extending ground flange segments 8 are fixedly attached to the outer surfaces of the tube segments 6, such attachments preferably being whole formations via plastic injection molding.

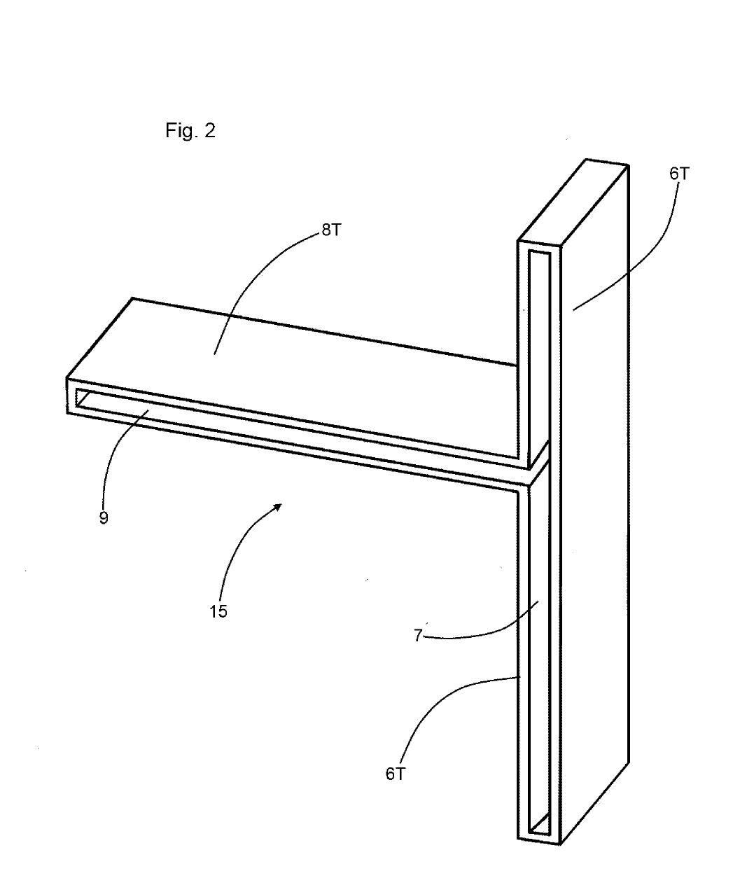

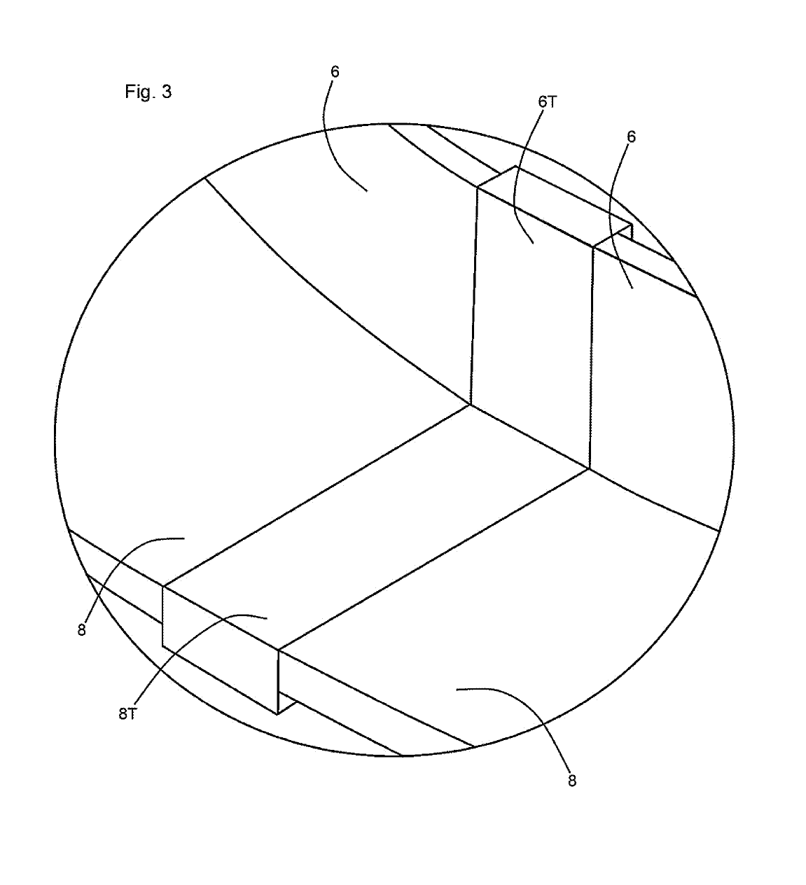

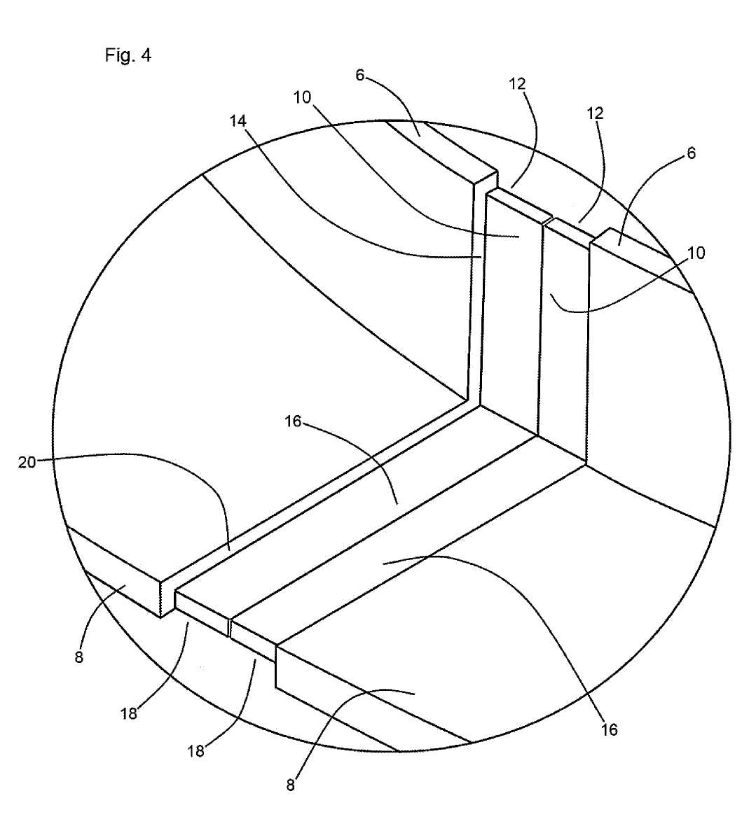

Referring simultaneously to FIGS. 1-4, the tube and ground flange combinations 6 and 8 may be seamed or jointed at even intervals in order to form and present the depicted assemblage of ring segments 4, each ring segment suitably having a 90° curve and being configured substantially identically with each other segment.

Fastening means for securely interconnecting the tube segments 6 and ground flange segments 8 are preferably provided, such means suitably comprising pairs of abutting flanges 10 and 16, such flange pairs 10,16 residing at and defining the assembly's seams.

The tube's flanges 10 are preferably specially fitted and sized with respect to the tube's exposed outer surfaces and with respect to the tube's exposed upper end, such fitting and sizing advantageously forming pluralities of “T” sleeve recesses 12 and 14. Flanges 16 are preferably similarly specially fitted and sized with respect to the upper surfaces and outer ends of the ground flange segments 8, such fitting and sizing similarly forming pluralities of “T” sleeve recesses 20 and 18.

The instant invention's fastening means preferably further comprise a plurality of “T” sleeves 15. Upon slidable end-to-end and abutting insertions of flanges 10 and 16 within the circumferentially opening hollow bores 7 and 13 of the “T” sleeves 15, the above described pluralities of recesses 12,14,18,20 advantageously nestingly receive upper ends and outer walls of the “T” sleeves' tube receiving sections 6T, and further nestingly receive outer ends and upper walls of the “T” sleeves' ground flange receiving sections 12T. According to the function of such recesses' nesting receipts of “T” sleeve components, all exposed upper and outer surfaces of the instant inventive tree ring are smooth and are substantially unobstructed. Such recessed positioning of such “T” sleeve structures effectively produces flush mountings of the “T” sleeves, leaving no exposed or protruding edges which might undesirably interfere with grass edging and trimming.

All of the instant inventive assembly's 90° arc segments 4 and “T” sleeves 15 are preferably interconnected in an identical fashion, allowing multiple renditions of identical segments 4 to be conveniently and efficiently interconnected.

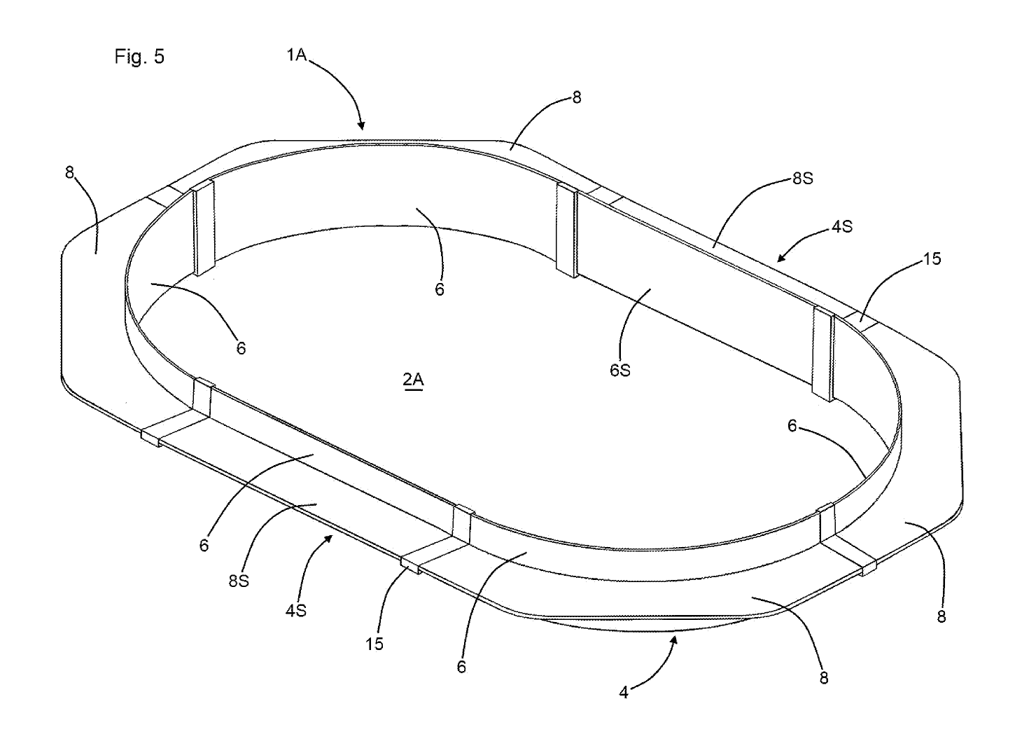

Referring simultaneously to FIGS. 1 and 5, the circular tree ring 1 of FIG. 1 may be easily and conveniently reconfigured to assume, for example, an oblongated tree ring 1A. Assembly of such alternative tree ring 1A may be facilitated by additionally providing straight segments 4S including straight tube sections 6S and straight ground flange sections 8S. Flanged ends of sections 4S are preferably configured substantially identically with the 90° curved segments 4 of the assembly. By providing both straight segments 4S and 90° curved segments 4, as indicated in FIG. 5, the depicted oblongated planting space 2A may be alternatively defined. Upon further alternatively providing segments configured to include inside curves, other planting shapes such as “T” shapes, and “L” shapes may be advantageously formed. In further suitable alternative ring segment configurations, 45° curved segments, 30° curved segments, or 60° curved segments (having both inside and outside curves) may be suitably additionally or alternatively provided.

The depicted hexagonal outer flange shape depicted in FIG. 1 advantageously compliments assembly of 90° and 45° arc segments. Other regular polygon shapes of the ground flange including hexagonal for facilitating 30° and 60° segment arcs are considered to fall within the scope of the invention. The octagonal ground flange shape of the tree ring 1 of FIG. 1 is intended to be representative of such other regular polygonal shapes.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A tree ring comprising:
(a) a tube having an upper end, a lower end, and an outer wall; and
(b) a ground flange having an outer end, the ground flange being fixedly attached to or formed wholly with the tube, the ground flange extending outwardly from the tube's outer wall, and the ground flange extending annularly about the tube.

2. The ring of claim 1 further comprising a plurality of seams, each seam among the plurality of seams segmenting the tube, said each seam among the plurality of seams correspondingly segmenting the ground flange.

3. The ring of claim 2 further comprising fastening means connected operatively at the seams, the fastening means being adapted for interconnecting the tube segments and the ground flange segments.

4. The ring of claim 3 wherein the fastening means comprise a plurality of paired flanges.

5. The ring of claim 4 wherein the fastening means further comprise a plurality of sleeves, each sleeve among the plurality of sleeves being fitted for receiving one of the flange pairs.

6. The ring of claim 5 wherein each sleeve among the plurality of sleeves comprises a “T” sleeve.

7. The ring of claim 6 wherein each flange among the plurality of paired flanges forms a plurality of sleeve receiving recesses.

8. The ring of claim 7 wherein each segment among the tube and ground flange segments has a configuration selected from the group consisting of a 90° arc configuration, a 45° arc configuration, a 30° arc configuration, a 60° arc configuration, and a straight configuration.

9. The ring of claim 8 wherein each “T” sleeve has upper, lower, and outer ends, and wherein each recess among the plurality of sleeve receiving recesses is fitted for nestingly receiving one of said ends.

10. The ring of claim 8 wherein the ground flange's outer end is octagonally or hexagonally shaped.
